(19) United States
(12) Patent Application Publication
(10) Pub. No.: US 2005/0226236 A1
(43) Pub. Date: Oct. 13, 2005

(54) Method for monitoring the availability of connections in mpls networks

(76) Inventor: Joachim Klink, Muenchen (DE)

Correspondence Address: Siemens Corporation;Intellectual Property Department, 170 Wood Avenue South, Iselin, NJ, 08830, US

(21) Appl. No.: 10/513,053

(22) PCT Filed: Apr. 24, 2003
(86) PCT No.: PCT/DE03/01337

§ 371 Date: Oct. 28, 2004

(30) Foreign Application Priority Data
Apr. 29, 2002 (DE) 102-19-154.9

(51) Int. Cl. H04L 12/56

(52) U.S. Cl. 370/389

(57) ABSTRACT

The invention relates to a low-effort method for monitoring the availability of connections in MPLS networks, according to which specially configured MPLS-OAM packets are defined and are periodically inserted into the traffic flow of user data packets at the source of a connection or a partial section of a connection, said specially configured MPLS-OAM packets being distinguishable from other MPLS-OAM packets and the MPLS packets carrying user data by means of a special mark or identifier. The specially configured MPLS-OAM packets are periodically checked for arrival thereof at the acceptor of the connection or the partial section of the connection. The connection is declared unavailable if none of said packets have been received within a predefined period of time.

### CROSS REFERENCE TO RELATED APPLICATIONS

This application is the US National Stage of International Application No. PCT/DE03/01337, filed Apr. 24, 2003 and claims the benefit thereof. The International Application claims the benefits of German application No. 10219154.9 filed Apr. 29, 2002, both of the applications are incorporated by reference herein in their entirety.

### FIELD OF INVENTION

The invention relates to a method for monitoring the availability of connections in MPLS networks.

### BACKGROUND OF INVENTION

In the prior art OAM (Operation and Maintenance) functionality is to be seen as a significant element of the operation of public communications networks. It supports the quality of the network performance while simultaneously reducing the operating costs of the network. It makes a significant contribution, especially with regard to the Quality of Service (QoS) of the information transmitted. Strategies in respect of OAM functionalities have already been proposed for SONET/SDH as well as for ATM networks.

### SUMMARY OF INVENTION

The OAM functionality allows the operator of a communications network to find out at any time whether the guaranteed quality-of-service levels (Service Level Agreement) for a connection are being adhered to. To be able to do this, the operator must also know the availability of existing connections (connection “up” or “down”), as well as the time delay for the transfer of the information (delay, delay variation), the—if necessary averaged—deviation from the otherwise normal gap between two information transfers (delay jitter) or the number of items of information not even allowed to be transferred (blocking rate, error performance).

If for example a connection fails, the fault must be determined immediately (fault detection), localized (fault localization) and the connection must also be able where necessary to be diverted to a standby route (protection switching). This enables both the traffic flow and the billing procedures in the network to be improved.

MPLS networks are currently proposed for transmissions of information in the Internet. In MPLS (Multiprotocol Packet Label Switching) networks information is transmitted by means of MPLS packets. MPLS packets are of variable length and each feature a header part and an information part. The header part is used to accommodate the connection information whereas the information part serves to accommodate payload information. IP packets are used as payload information. The connection information contained in the header part is embodied as an MPLS connection number. This number is only valid in the MPLS network however. This means that when an IP packet from an Internet network penetrates into the MPLS network (FIG. 1), this packet will be prefixed with the header part valid in the MPLS network. This header contains all the connection information which specifies the route of the MPLS packet in the MPLS network. If the MPLS packet leaves the MPLS network, the header part is removed again and the IP packet is routed onwards in the subsequent Internet network in accordance with the IP protocol. MPLS packets are transmitted unidirectionally.

FIG. 1 starts off from the typical assumption that information will for example be routed from a subscriber TLN1 to a subscriber TLN2. The sending subscriber TLN1 is connected in this case to the Internet network IP through which the information is routed in accordance with an Internet protocol, such as the IP protocol. This protocol is not a connection-oriented protocol The Internet network IP features a plurality of routers R which can be intermeshed. The receiving subscriber TLN2 is connected to a further Internet network IP. An MPLS network is inserted between the two Internet networks IP, through which packet-oriented information is switched in the form of MPLS packets. This network likewise features a plurality of intermeshed routers. In an MPLS network these can be so-called Label Switched Routers (LSR).

In MPLS networks the guarantee of Quality of Service (QoS) assumes major significance. In particular the knowledge of the availability of existing connections is an important aspect for the networkoperator, since protection switching can be undertaken and statistics maintained in accordance with this information. However the prior art does not contribute in any way to resolving this problem.

The object of the invention is to demonstrate a way in which information about packets lost or incorrectly inserted during transmission can be made available with minimal effort in MPLS networks.

The object of the invention is achieved by the claims.

Especially advantageous in the invention is the provision of specifically embodied MPLS-OAM packets which are inserted into the traffic stream of payload data packets. In addition to the mark or identification in the header identifying the packet as an MPLS OAM packet (to distinguish between the MPLS OAM packets and MPLS packets carrying payload data) a further identification is required. The packets defined in this way (referred to below as MPLS-OAM-LAV packets) are now used for performance monitoring (verification) of the availability of an MPLS connection (MPLS Label Switched Path) by being inserted periodically at the source of a connection segment into the packet flow of the total packets transferred and by a check being periodically made at the sink of the connection segment for their arrival. The Label Switched Path (LSP) to be monitored is declared as not available if none of the OAM-LAV packets have been received after a predefined time.

Advantageous developments of the invention are specified in the dependent claims.

The invention will be explained below in more detail using an exemplary embodiment.

The diagrams show:

### BRIEF DESCRIPTION OF THE DRAWINGS

FIG. 1 the basic circumstances in an MPLS network

FIG. 2 an end-to-end connection between two subscribers

FIG. 3 the circumstances in the packet header and in the information part of an MPLS-OAM packet

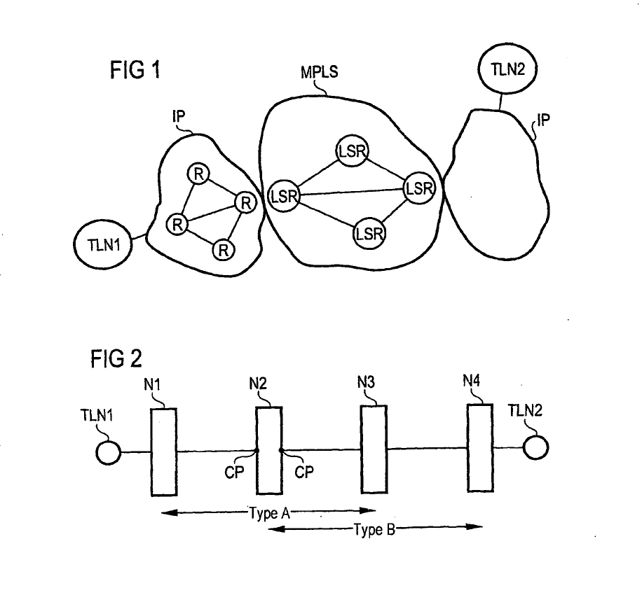

### DETAILED DESCRIPTION OF INVENTION

FIG. 2 shows a connection (Label Switched Path, LSP) between two subscribers TLN1, TLN2. This connection is routed via a plurality of nodes N1 . . . N4, which means that a plurality of connection hops (Label Switched Hop) are defined. The nodes N4 . . . N4 should be embodied as Label Switched Routers (LSRs) of an MPLS network. After a successful connection setup information is now flowing between subscriber TLN1 and subscriber TLN2 comprising a plurality of MPLS packets carrying payload data information. MPLS-OAM packets can be inserted into this MPLS packet flow (Inband LSP). By contrast connections are defined via which exclusively MPLS-OAM packets are routed (Outband LSP). Basically inband MPLS-OAM packets are useful for logging LSP connections on an individual basis. In a few cases however it can be advantageous to define an Out-of-Band MPLS-OAM packet flow. One example of this is MPLS group protection switching.

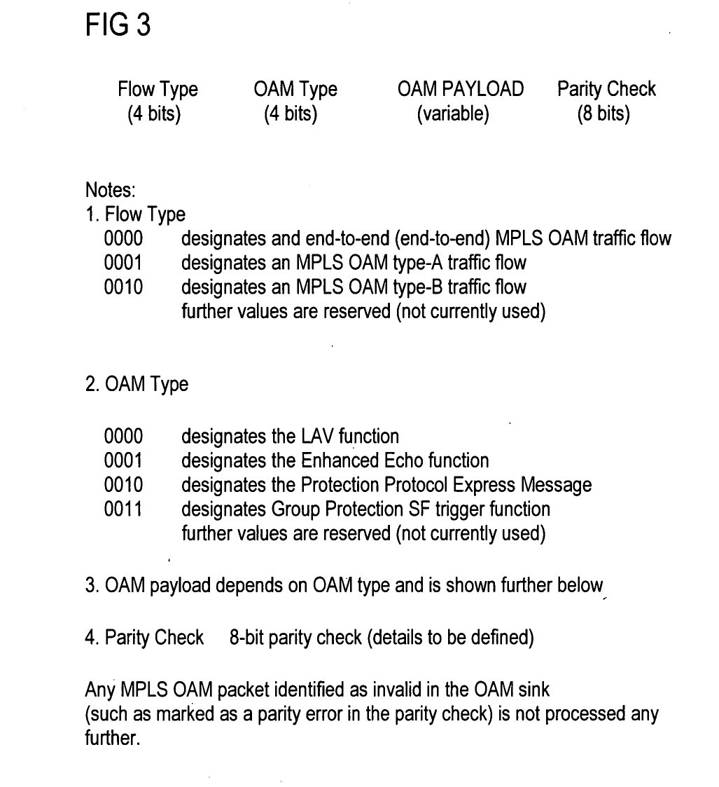

To enable a distinction to be made between MPLS-OAM packets and MPLS packets carrying payload data, the MPLS-OAM packets are marked. The special marking mechanisms are shown in FIG. 3 and are described later in greater detail.

The sequence of a number of MPLS-OAM packets defines an MPLS-OAM packet flow. Basically 3 different types of MPLS-OAM packet flows can exist simultaneously for an LSP connection:

End-to-end MPLS-OAM packet flow. This is used in particular if there is OAM communication between a source and a sink of an LSP. It is formed from MPLS-OAM packets which are inserted into the payload data stream in the source of the LSP connection and are removed again at the sink. The MPLS-OAM packets can be recorded and monitored along the LSP connection at the Connection Point CP without the need for intervention into the transmission process (passive monitoring).

One of the end-to-end defined MPLS-OAM packet flows is the MPLS-OAM packet flow type A. It is used in particular if there is OAM communication between the nodes which delimit a type-A connection segment (FIG. 2). One or more type-A MPLS-OAM segments can be defined in the LSP connection, but they can neither be interleaved nor can they overlap with other type-A segments.

Finally, of the two types of packet flow specified below, type-B MPLS-OAM packet flow is identified. It is used in particular if there is OAM communication between the nodes which delimit the type-B connection segment (FIG. 2). One or more type-B MPLS-OAM segments can be defined in the LSP connection, but they can neither be interleaved nor can they overlap with other type-B segments.

Basically an MPLS-OAM packet flow (end-to-end, type A, type B) is made up of MPLS-OAM packets which are inserted at the start of a segment into the payload data stream and removed from this stream again at the end of the segment. They can be recorded and processed
along the LSP connection at the Connection Point CP without the need for intervention into the transmission process. Each Connection point CP in the LSP connection including the sources and sinks of the connection can be configured as MPLS-OAM source or MPLS-OAM sink, in which case the outgoing MPLS-OAM packets from an MPLS-OAM source are preferably to be configured as “upstream”.

Before MPLS-OAM packets (end-to-end, type A, type B) are transmitted over the MPLS network, the end points (source, sink) of the associated MPLS-OAM segment must be defined. The definition of source and sink for an MPLS-OAM segment is not necessarily set for the duration of the connection. This means for example that the segment involved can be reconfigured via fields in the signalling protocol.

For each LSP connection interleaving of the segmented MPLS-OAM packet flow (type A or type B) within an end-to-end MPLS-OAM packet flow is possible. In this case the Connection Points CP can simultaneously be source/sink of a segment flow (type A or type B) and also of the end-to-end MPLS-OAM packet flow.

The MPLS-OAM packet flow (segment flow) of type A is functionally independent of that of type B with regard to the insertion, removal and the processing of the MPLS-OAM packets. In general it is thus possible to interleave type-B MPLS-OAM packets with those of Type A and vice versa. In the case of interleaving a Connection point CP can thus also simultaneously be source and sink of an OAM segment flow of type A and of type B.

The overlapping of the type A segments with those of type B is possible depending on the network architecture. For example in the case of a point-to-point-network architectures segments of type A
can overlap with those of type B. Both segments can operate independently and will thus not influence each other in any way. In MPLS protection switching however the overlapping can lead to problems.

The MPLS-OAM packets can be distinguished from MPLS packets carrying payload data by using one of the EXP bits in the MPLS packet header. This method in particular provides a very simple method of distinguishing between packets. This bit can be checked in the sink of an MPLS-OAM segment or at the Connection points CP to filter out MPLS-OAM packets before further evaluation is undertaken.

Alternatively one of the MPLS label values No. 4 to No. 15 can be used as an identifier in the header part of the MPLS packet. These MPLS label values are reserved by the IANA. In this case the next identification in the stack of the assigned LSP connection must indicate what the OAM functionality is used for. This approach to a solution is rather more complex to implement since the hardware in the OAM sink and the Connection points CP needs two MPLS stack entries for each MPLS-OAM packet. Naturally processing must take place in real time, i.e. in the Connection Points CP the OAM packets must be inserted back into the flow while retaining the sequence. This is absolutely necessary to ensure correct performance monitoring results in the OAM sink.

For verification of the availability of an MPLS-LSP connection (referred to below as the MPLS-LAV function, MPLS-OAM-LAV packets are defined. They are inserted into the flow of the payload information (in-band flow) and are assigned to a specific LSP connection. Thus the availability of an LSP connection can be determined on an end-to-end basis or a segmented basis.

For this purpose an MPLS-OAM-LAV packet is inserted periodically per time interval (e.g. per second) at the source and is monitored periodically per time interval (e.g. per second) at the sink for its arrival. If, after a predefined time (of a number of seconds for example) and if necessary multiple checks (e.g. 2 to 3 times) no MPLS-OAM-LAV packet has been received at the sink, the LSP connection is declared as not available (LSP=“down” or “unavailable”). In the case of the non-available LSP connection further periodic checks are made at the sink for the arrival of the MPLS-OAM-LAV packet, and if, after a predefined period (of several seconds) this is received at the sink again, the connection is declared as available again.

The MPLS-LAV function can be activated simultaneously on an end-to-end basis or segmented basis for each LSP connection at any interface CP or network element. Activation and deactivation is just as possible using signalling procedures as it is using manual configuration via network management. The feature can be activated at any time, that is either during connection setup or afterwards.

If a segment is monitored it is first necessary to define the limits of the segment involved with the assigned LSP connection. This is generally done by determining source and sink. After this the MPLS-LAV function can then be activated. It must however be inactive if the limits of a segment are to be changed or the segment is to be deleted, which is possible at any time.

The advantage of the MPLS-LAV function lies in its ability to check whether the quality of service parameters in the service level agreement of the LSP connection involved have also been adhered to. The avail;ability status is especially of interest here, i.e. whether the LSP connection is available (LSP=“up” or “available”) or not (LSP=“down” or “unavailable”). This allows the failure of an LSP connection (Signal Fail Situations) to be determined. In this case MPLS protection switching can be initiated or an alarm, which is forwarded to the network operator if necessary, can be generated.

When the MPLS-LAV function is activated, a special MPLS-OAM packet (the MPLS-OAM-LAV packet) is inserted into the flow of MPLS-OAM packets of the assigned LSP connection. The insertion into the source is undertaken once per time interval (per second) through a free-running counter assigned here.

As explained below, the MPLS-OAM-LAV packets arrive after successful transmission over the connection segment arranged between the source and sink per time interval (second) in the sink. In this case a further counter arranged there “Time since last LAV 1p” is set to zero. Every time an MPLS-OAM-LAV packet arrives in the sink (once per second as a rule), this packet is unpacked and a bit “LAV lp received” is set to TRUE for the LSP connection involved. With the aid of the (free running) counter arranged in the sink the status of this bit “LAV lp received” is now checked once per second for the LSP connection:

When the bit “LAV-lp_received” is set to FALSE the counter “Time_since last LAV-lp” is incremented by 1 for as long as the counter status is less than 3. If it is exactly 3, the counter status remains unchanged and the status of the associated LSP connection is set to not available (LSP=“down” or “unavailable”).

If the bit “LAV 1p_received” is set to TRUE the counter “Time_since last LAV_{—}1p” is decremented by 1 for as long as the counter status is less than 0. If it is exactly 0, the counter status remains unchanged and the status of the associated LSP connection is set to available (“LSP=“up” or “available”). The bit “LAV lp received” is then set to FALSE.

The availability status of the LSP connection (LSP=“available”, LSP=“unavailable”) is now taken as the basis for further information. Thus the availability status is an indication for the occurrence of the failure of a connection (Signal Fail Situation). In the case of non-availability a “Signal Fail” signal is activated. In the case of availability of the connection this signal is deactivated. With the aid of this signal protection switching requests (MPLS Protection Switching) or alarms can then be initiated. Furthermore the location of the underlying network fault can be determined as part of diagnostic measures.

As an additional function for the monitoring function (MPLS-LAV function) a further purely passive monitoring function (non-intrusive monitoring function) can be provided. With this function the MPLS-OAM-LAV packets are only read during the monitoring procedure but are not modified (non-intrusive). They can be determined at each of the Connection Points CP along the MPLS-OAM-LAV traffic flow on an end-to-end basis or segment basis by the content of the MPLS-OAM-LAV packets passing the Connection Point CP being processed without characteristic values such as the content of the packets for example being changed. Monitoring is also undertaken end-to-end, i.e. in this case individual connection segments of the overall connection are checked. In this case passive monitoring includes that same functionality as that described for the MPLS-LAV function.

The advantage of the passive monitoring function is to be seen in fault localization. With this a step-by-step method can be implemented which allows the parts of the LSP connection which are interrupted to be determined. The signal degrade can thus be determined.

1-9. (canceled)

10. A method for connection-oriented transmission of variable-length packets via a connection formed by a plurality of connection segments, comprising:
marking some of the packets with an identification;
marking some of these marked packets with a further identification;
periodically inserting the packets marked with the further identification into a packet stream of the packets at a source of a connection segment;
periodically checking an arrival of the packets marked with the further identification at a sink of the connection segment; and
declaring the connection unavailable if none of the packets marked with the further identification has been received after elapse of a prespecified time period.

11. The method according to claim 10, wherein the variable-length packets are transmitted in accordance with a Multi Protocol Label Switching (MPLS) method of transmission, wherein
these packets are defined as MPLS packets, wherein
the marked MPLS packets are defined as MPLS-OAM packets, and wherein
the MPLS-OAM packets provided with a further identifier are defined as MPLS-OAM-LAV packets.

12. The method according to claim 11, wherein even for a connection declared as unavailable periodic checks continue to be made at the sink for the arrival of an MPLS-OAM-LAV packet, and in the case that, after a predefined period, MPLS-OAM-LAV packets are received again, the connection is again declared as available.

13. The method according to claim 11, wherein the MPLS-OAM-LAV packets are formed as a segment MPLS-OAM traffic flow, and are transferred within a connection segment of the connection, thereby monitoring an availability of the connection segment.

14. The method according to claim 12, wherein the MPLS-OAM-LAV packets are formed as a segment MPLS-OAM traffic flow, and are transferred within a connection segment of the connection, thereby monitoring an availability of the connection segment.

15. The method according to claim 10, wherein information related to the unavailability of the connection or of the connection segment is forwarded to a network operator or conveyed to a protection switching mechanism for initiating protection switching measures for the connection or the connection segment of the connection.

16. The method according to claim 11, wherein information related to the unavailability of the connection or of the connection segment is forwarded to a network operator or conveyed to a protection switching mechanism for initiating protection switching measures for the connection or the connection segment of the connection.

17. The method according to claim 12, wherein information related to the unavailability of the connection or of the connection segment is forwarded to a network operator or conveyed to a protection switching mechanism for initiating protection switching measures for the connection or the connection segment of the connection.

18. The method according to claim 13, wherein information related to the unavailability of the connection or of the connection segment is forwarded to a network operator or conveyed to a protection switching mechanism for initiating protection switching measures for the connection or the connection segment of the connection.

19. The method according to claim 11, wherein
any subsegments of a connection segment arranged between the source and the sink are monitored, wherein
the connection for the connection segment is declared unavailable if after the elapse of the prespecified time period no MPLS-OAM-LAV packets are received, and wherein
the connection is declared available for the connection segment in case MPLS-OAM-LAV packets are received after the elapse of the prespecified time.

20. The method according to claim 12, wherein
any subsegments of a connection segment arranged between the source and the sink are monitored, wherein
the connection for the connection segment is declared unavailable if after the elapse of the prespecified time period no MPLS-OAM-LAV packets are received, and wherein
the connection is declared available for the connection segment in case MPLS-OAM-LAV packets are received after the elapse of the prespecified time.

21. The method according to claim 13, wherein
any subsegments of a connection segment arranged between the source and the sink are monitored, wherein
the connection for the connection segment is declared unavailable if after the elapse of the prespecified time period no MPLS-OAM-LAV packets are received, and wherein
the connection is declared available for the connection segment in case MPLS-OAM-LAV packets are received after the elapse of the prespecified time.

22. The method according to claim 15, wherein
any subsegments of a connection segment arranged between the source and the sink are monitored, wherein
the connection for the connection segment is declared unavailable if after the elapse of the prespecified time period no MPLS-OAM-LAV packets are received, and wherein
the connection is declared available for the connection segment in case MPLS-OAM-LAV packets are received after the elapse of the prespecified time.

23. The method according to claim 10, wherein information related to availability of a connection is used in any network equipment arranged between the source and the sink for locating a network fault within a framework of diagnostic measures.

24. The method according to claim 11, wherein information related to availability of a connection is used in any network equipment arranged between the source and the sink for locating a network fault within a framework of diagnostic measures.

25. The method according to claim 12, wherein information related to availability of a connection is used in any network equipment arranged between the source and the sink for locating a network fault within a framework of diagnostic measures.

26. The method according to claim 10, wherein monitoring an availability of a connection at the source and the sink can be activated or deactivated by a user using network signaling or by a network management initiating control sequences.

27. The method according to claim 11, wherein monitoring an availability of a connection at the source and the sink can be activated or deactivated by a user using network signaling or by a network management initiating control sequences.

28. The method according to claim 11, wherein information not related to availability of an MPLL connection is transmitted within a MPLS-OAM-LAV packet.

29. The method according to claim 28, wherein the information not related to availability of an MPLL connection is used for operating and monitoring the communication network.
